(19) United States
(12) Patent Application Publication
(10) Pub. No.: US 2026/0289876 A1
(43) Pub. Date: Sep. 24, 2026

(54) METHODS, SYSTEMS, DEVICES, AND STORAGE MEDIA FOR DYNAMIC MEDICAL IMAGING

(71) Applicant: SHANGHAI UNITED IMAGING HEALTHCARE CO., LTD., Shanghai (CN)

(72) Inventors: Hongyu LI, Houston, TX (US); Hanrui SHI, Houston, TX (US); Hongyi GU, Houston, TX (US); Yongquan YE, Houston, TX (US); Qi LIU, Houston, TX (US); Jian XU, Houston, TX (US)

(73) Assignee: SHANGHAI UNITED IMAGING HEALTHCARE CO., LTD., Shanghai (CN)

(21) Appl. No.: 19/565,512

(22) Filed: Mar. 13, 2026

(30) Foreign Application Priority Data
Mar. 19, 2025 (CN) 202510329723.4

(51) Int. Cl. G06T 12/20; G06T 5/50; G06T 5/60; G06T 5/70; G06T 12/10

(52) U.S. Cl. CPC G06T 12/20; G06T 5/50; G06T 5/60; G06T 5/70; G06T 12/10; G06T 2207/10081; G06T 2207/10088; G06T 2207/20081; G06T 2207/30048; G06T 2211/441

(57) ABSTRACT

Disclosed is a method for dynamic medical imaging, a system for dynamic medical imaging, a device for dynamic medical imaging, and a non-transitory computer-readable storage medium. The method includes: obtaining a plurality of first images of a target object corresponding to a plurality of phases, each of the plurality of first images corresponding to one of the plurality of phases; generating a reference image based on first images corresponding to at least two of the plurality of phases; and generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image.

### CROSS REFERENCE TO RELATED APPLICATIONS

This application claims the priority to Chinese patent application No. 202510329723.4 filed on Mar. 19, 2025, the entire content of which are incorporated herein by reference.

### TECHNICAL FIELD

The present disclosure generally relates to a field of medical imaging, and in particular to a method, a system, a device, and a non-transitory computer-readable storage medium for dynamic medical imaging.

### BACKGROUND

Dynamic medical imaging can observe and evaluate dynamic changes of human organs and tissues within a certain period of time. Taking cardiac magnetic resonance cine imaging as an example, the cardiac magnetic resonance cine imaging provides comprehensive information about heart and plays a key role in diagnosis and management of heart. However, to capture fast real-time dynamic information, each phase of the cardiac magnetic resonance cine imaging cannot fully acquire signals required for image reconstruction, resulting in poor quality of reconstructed images. Current deep learning-based cardiac cine reconstruction techniques are mainly implemented by different feature extractors designed by convolutional network. However, a convolutional neural network causes temporal and spatial blurring, making it difficult to recover high-frequency image details, thereby leading to degradation of the quality of the reconstructed images.

Based on this, it is necessary to provide a method for dynamic medical imaging to reconstruct high-quality images based on originally acquired images, thereby providing clearer and more accurate reconstructed images to help users better utilize the reconstructed images for diagnosis.

### SUMMARY

One or more embodiments of the present disclosure provide a method for dynamic medical imaging. The method for dynamic medical imaging includes: obtaining a plurality of first images of a target object corresponding to a plurality of phases, each of the plurality of first images corresponding to one of the plurality of phases; generating a reference image based on first images corresponding to at least two of the plurality of phases; and generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image

In some embodiments, the generating a reference image based on the first images corresponding to at least two of the plurality of phases includes: determining at least two k-space datasets by performing a Fourier transform on the first images corresponding to the at least two of the plurality of phases; determining reference k-space data by combining the at least two k-space datasets; and generating the reference image by performing an inverse Fourier transform on the reference k-space data.

In some embodiments, the generating a reference image based on the first images corresponding to at least two of the plurality of phases includes: generating the reference image by combining pixel values or voxel values of the first images corresponding to the at least two of the plurality of phases.

In some embodiments, the generating a plurality of second images by inputting the plurality of first images and the reference image into an image processing model includes: for each of the plurality of first images, performing a plurality of rounds of image processing on the first image based on the reference image, each of the plurality of rounds of image processing including: generating an output image by denoising, based on the reference image, an input image, the input image being the first image or an output image of a previous round of image processing; and determining the output image of a last round of image processing as the second image corresponding to the first image.

In some embodiments, the generating an output image by denoising, based on the reference image, an input image includes: generating a denoised image by denoising, based on the reference image, the input image; and generating the output image by performing, based on the first image, data consistency processing on the denoised image.

In some embodiments, the generating the output image by performing, based on the first image, data consistency processing on the denoised image includes: determining first k-space data by performing a Fourier transform on the first image; determining second k-space data by performing a Fourier transform on the denoised image; determining third k-space data based on the first k-space data and the second k-space data; and generating the output image by performing an inverse Fourier transform on the third k-space data.

In some embodiments, the image processing model is a deep learning model based on a conditional diffusion model.

In some embodiments, the image processing model is provided by: obtaining training samples, the training samples including a plurality of sample first images and a plurality of sample second images corresponding to a plurality of sample phases of a sample object, each of the plurality of sample first images corresponding to one of the plurality of sample phases, each of the plurality of sample second images corresponding to one of the plurality of sample first images, and an image quality of each of the plurality of sample first images being lower than an image quality of the sample second image corresponding to the sample first image; determining a sample reference image based on sample first images corresponding to at least two of the plurality of sample phases; and obtaining the image processing model by training, based on the training samples, an initial image processing model.

In some embodiments, the obtaining the image processing model by training, based on the training samples, an initial image processing model includes: generating a plurality of noisy images by adding noise to one of the plurality of sample second images multiple times; selecting one of the plurality of noisy images as a target noisy image; determining predicted noise by inputting the target noisy image and the sample reference image into the initial image processing model; determining a loss value of a loss function based on the predicted noise and the noise corresponding to the target noisy image; and obtaining the image processing model by updating, based on the loss value, the initial image processing model.

In some embodiments, the obtaining the image processing model by training, based on the training samples, an initial image processing model further includes: generating a sample denoised image based on the target noisy image and the sample reference image; and determining the loss value of the loss function by comparing the sample denoised image with at least one of a preceding noisy image of the target noisy image, the sample reference image, or the one of the plurality of sample second images

In some embodiments, the generating a sample denoised image based on the target noisy image and the sample reference image includes: generating an intermediate image based on the target noisy image and the sample reference image; and generating the sample denoised image by performing, based on the preceding noisy image of the target noisy image, data consistency processing on the intermediate image.

One or more embodiments of the present disclosure provide a system for dynamic medical imaging. The system for dynamic medical imaging includes: at least one storage medium including a set of instructions; and at least one processor in communication with the at least one storage medium, wherein when executing the set of instructions, the at least one processor is directed to cause the system to perform operations including: obtaining a plurality of first images of a target object corresponding to a plurality of phases, each of the plurality of first images corresponding to one of the plurality of phases; generating a reference image based on first images corresponding to at least two of the plurality of phases; and generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image.

One or more embodiments of the present disclosure provide a device for dynamic medical imaging. The device for dynamic medical imaging includes a processor. The processor is configured to execute the method for dynamic medical imaging.

One or more embodiments of the present disclosure provide a non-transitory computer-readable storage medium. The non-transitory computer-readable storage medium stores computer instructions. In response to a computer reading the computer instructions in the non-transitory computer-readable storage medium, the computer executes the method for dynamic medical imaging.

### BRIEF DESCRIPTION OF THE DRAWINGS

The present disclosure is further described in an illustrative manner by way of exemplary embodiments. These exemplary embodiments are described in detail with reference to the accompanying drawings. These embodiments are not limiting. In these embodiments, the same reference numerals denote the same structure.

FIG. 1 is a schematic diagram illustrating an exemplary system for dynamic medical imaging according to some embodiments of the present disclosure;

FIG. 2 is a block diagram illustrating an exemplary system for dynamic medical imaging according to some embodiments of the present disclosure;

FIG. 3 is a flowchart illustrating an exemplary process for dynamic medical imaging according to some embodiments of the present disclosure;

FIG. 4 is a schematic diagram illustrating an exemplary process for generating a second image according to some embodiments of the present disclosure;

FIG. 5 is a schematic diagram illustrating exemplary data consistency processing according to some embodiments of the present disclosure;

FIG. 6 is a schematic diagram illustrating an exemplary process for generating a second image according to other embodiments of the present disclosure;

FIG. 7 is a schematic diagram illustrating an exemplary training process of an image processing model according to some embodiments of the present disclosure; and

FIG. 8 is a schematic diagram illustrating an exemplary training process of an image processing model according to other embodiments of the present disclosure.

### DETAILED DESCRIPTION

The illustrate the technical solutions of the embodiments of the present disclosure more clearly, the following briefly introduces the accompanying drawings required for describing the embodiments. Obviously, the accompanying drawings in the following description are merely some examples or embodiments of the present disclosure. For those skilled in the art, the present disclosure may be applied to other similar scenarios based on these drawings without creative efforts. Unless obviously acquired from the context or the context illustrates otherwise, the same numeral in the drawings refers to the same structure or operation.

It should be understood that the terms “system,” “device,” “unit,” and/or “module” used herein are a method for distinguishing different components, elements, parts, sections, or assemblies at different levels. However, if other words can achieve the same purpose, the words may be replaced by other expressions.

As shown in the present disclosure and the claims, unless the context clearly indicates an exception, the words “a,” “an,” “one,” and/or “the” are not specifically limited to the singular and may also include the plural. Generally, the terms “include” and “contain” only indicate the inclusion of explicitly identified steps and elements. These steps and elements do not constitute an exclusive list. A method or device may also include other steps or elements.

The present disclosure uses flowcharts to illustrate operations performed by a system according to embodiments of the present disclosure. It should be understood that preceding or following operations are not necessarily performed precisely in sequence. Instead, the steps may be processed in reverse order or simultaneously. Meanwhile, other operations may be added to these processes, or one or more operations may be removed from these processes.

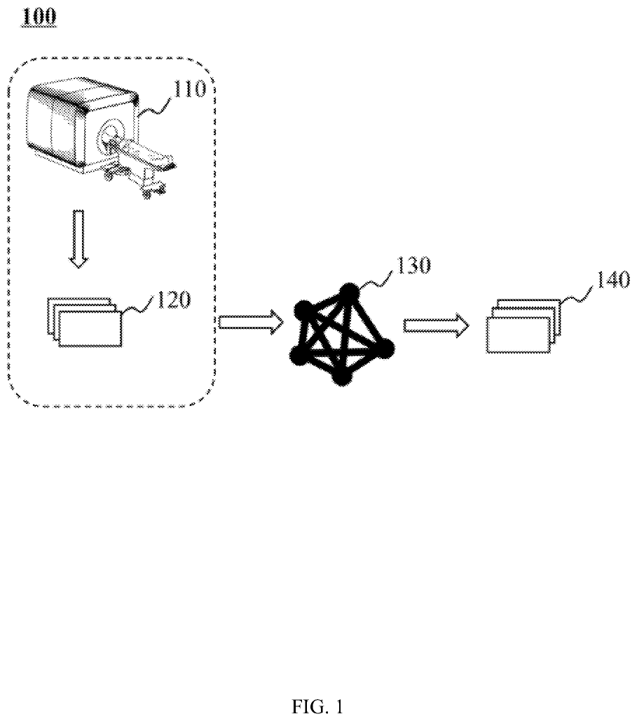

FIG. 1 is a schematic diagram illustrating an exemplary system for dynamic medical imaging according to some embodiments of the present disclosure. As shown in FIG. 1, a system 100 for dynamic medical imaging includes an imaging device 110, first images 120, an image processing model 130, and second images 140. The dynamic medical imaging includes cardiac magnetic resonance imaging (MRI) (e.g., cardiac MRI cine). The dynamic medical imaging may also include dynamic MRI of other body parts (e.g., brain), and/or dynamic imaging of other modalities (e.g., computed tomography (CT), etc.).

The imaging device 110 is configured to obtain the first images 120. In some embodiments, the imaging device 110 includes at least one of a single-modality scanner, a multi-modality scanner, or the like. The single-modality scanner includes a computed tomography (CT) scanner, an MRI scanner, or the like, or any combination thereof. The multi-modality scanner may include, for example, a computed tomography-magnetic resonance imaging (MRI-CT) device, a positron emission tomography-magnetic resonance imaging (PET-MRI) device, a single photon emission computed tomography-magnetic resonance imaging (SPECT-MRI) device, a digital subtraction angiography-magnetic resonance imaging (DSA-MRI) device, a positron emission tomography-magnetic resonance imaging (PET-CT) device, etc.

The first image 120 refers to an undersampled image obtained by the imaging device 110. For example, during a scanning process of a target object, the imaging device 110 undersamples k-space to obtain undersampled k-space data, and a processing device reconstructs the undersampled k-space data to obtain the first images 120 by, e.g., performing an inverse Fourier transform on the undersampled k-space data. The first image 120 may includes a two-dimensional (2D) image or a three-dimensional (3D) image.

The target object refers to an object that requires medical imaging. For example, the target object may be a body part or an organ (e.g., the heart, the lung, a blood vessel, or the like) of a patient, an experimental subject, or the like.

The k-space refers to a space for storing frequency domain data of an image. In some embodiments, the k-space includes a two-dimensional matrix or a three-dimensional matrix for storing image data.

Fourier transform refers to a calculation manner for converting spatial domain (also referred to as image domain) data or signals into frequency domain data or signals. Inverse Fourier transform is an inverse process of the Fourier transform. The inverse Fourier transform refers to a calculation manner for converting frequency domain data or signals into spatial domain data or signals.

The image processing model 130 refers to a model for generating the second images 140. In some embodiments, the image processing model 130 is a machine learning model. In some embodiments, the image processing model 130 is a deep learning model based on a conditional diffusion model.

The image processing model 130 may be implemented in a processing device. In some embodiments, the processing device 140 may be a single server, or a server group. The server group may be centralized or distributed. In some embodiments, the processing device may be local or remote. For example, the processing device may access information and/or data stored in or acquired by the imaging device 110 via a network. As another example, the processing device may be directly connected to the imaging device 110 to access stored or acquired information and/or data. In some embodiments, the processing device may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device may include a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

The network may include any suitable network that can facilitate the exchange of information and/or data for the system 100. The network may be any type of wired or wireless network, or a combination thereof. The network may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network, etc.), a cellular network (e.g., a Long Term Evolution (LTE) network), a frame relay network, a virtual private network (“VPN”), a satellite network, a telephone network, routers, hubs, switches, server computers, and/or any combination thereof. Merely by way of example, the network may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network may include one or more network access points. For example, the network may include wired and/or wireless network access points such as base stations and/or internet exchange points through which one or more components of the system 100 may be connected to the network to exchange data and/or information.

The second image 140 refers to a high-quality image generated by processing, reconstructing, or optimizing the first image 120. An image quality of each of the second images 140 is higher than an image quality of a corresponding first image 120. The image quality may be characterized by resolution, signal-to-noise ratio, contrast, or the like.

In some embodiments, the imaging device 110 obtains the first images 120 and inputs the first images 120 into the image processing model 130. The image processing model 130 generates the second images 140 based on the first images 120 and a reference image.

In some embodiments, the system 100 may further include a storage device. In some embodiments, the storage device may store data and/or instructions that the processing device may execute or use to perform exemplary methods described in the present disclosure. In some embodiments, the storage device 150 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, one or more components of the system 100 may access the data or instructions stored in the storage device via the network. In some embodiments, the storage device may be directly connected to or communicate with one or more components of the system 100. In some embodiments, the storage device may be part of the processing device.

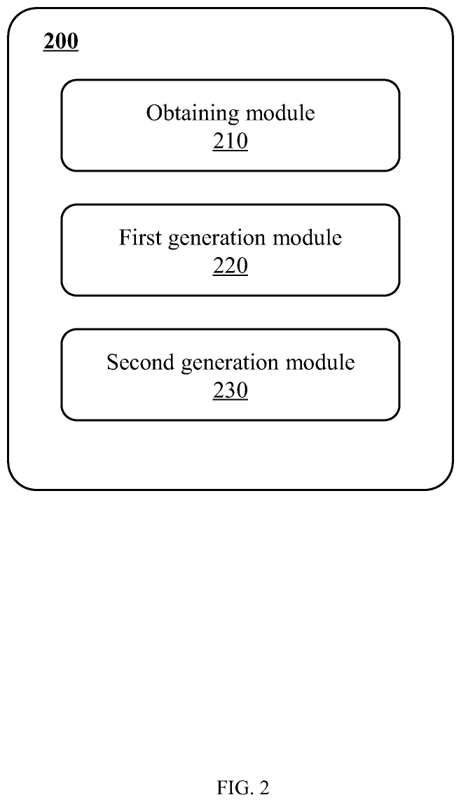

FIG. 2 is a block diagram illustrating an exemplary system for dynamic medical imaging according to some embodiments of the present disclosure. In some embodiments, as shown in FIG. 2, a system 200 for dynamic medical imaging includes an obtaining module 210, a first generation module 220, and a second generation module 230. The system 200 may be implemented on the processing device described in FIG. 1.

The obtaining module 210 is configured to obtain a plurality of first images of a target object corresponding to a plurality of phases.

The first generation module 220 is configured to generate a reference image based on first images corresponding to at least two of the plurality of phases.

The second generation module 230 includes the image processing model. In some embodiments, the second generation module 230 is configured to input the plurality of first images and the reference image into the image processing model to generate a plurality of second images.

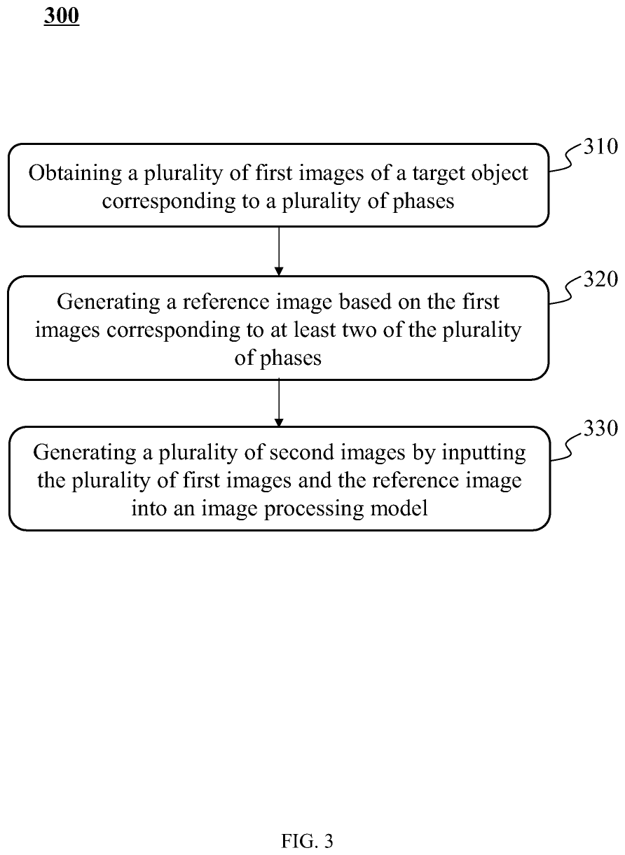

More descriptions regarding operations performed by the system 200 may be found in FIG. 3 to FIG. 8 and related descriptions.

It should be noted that the description of the system for dynamic medical imaging 200 and the modules of the system for dynamic medical imaging 200 is merely for convenience of description and does not limit the scope of the present disclosure to the illustrated embodiments. It is to be understood that, after understanding principles of the system for dynamic medical imaging 200, those skilled in the art may combine the modules arbitrarily or form subsystems to connect with other modules without departing from the principles. In some embodiments, the obtaining module 210, the first generation module 220, and the second generation module 220 disclosed in FIG. 2 may be different modules in a system, or a single module may implement functions of two or more of the modules described above. For example, the modules may share a storage module, or each of the modules may have a respective storage module. Such modifications are within a protection scope of the present disclosure.

FIG. 3 is a flowchart illustrating an exemplary process for dynamic medical imaging according to some embodiments of the present disclosure. As shown in FIG. 3, a process 300 includes the following operations. In some embodiments, the process 300 may be performed by the system 200 and/or the processing device.

In 310, a plurality of first images of a target object corresponding to a plurality of phases are obtained. In some embodiments, operation 310 is performed by the processing device and/or the obtaining module 210.

A first image (e.g., a first image 120) refers to an undersampled image acquired by an imaging device (e.g., the imaging device 110). For example, the imaging device acquires raw data (e.g., k-space data in MRI or projection data in CT) of the target object by scanning the target object in the plurality of phases. The raw data may be transmitted to the processing device for reconstruction to generate the plurality of first images. More descriptions regarding the first image and the target object may be found in FIG. 1 and related descriptions.

A phase refers to a period of time in a physiological motion process (e.g., heartbeat, respiration, blood flow, pulse, etc.) of the target object. Taking heartbeat as an example, a heartbeat cycle may be divided into different phases, such as a systole and a diastole. The systole refers to a period when the heart contracts to pump blood, and the diastole refers to a period when the heart relaxes and fills with blood to prepare for a next contraction.

In some embodiments, each of the plurality of first images corresponds to one of the plurality of phases. In some embodiments, there is a one-to-one correspondence between the plurality of first images and the plurality of phases. The plurality of first images may dynamically display motion conditions of the target object in a physiological motion process (e.g., a continuous heartbeat process of the heart).

In 320, a reference image is generated based on first images corresponding to at least two of the plurality of phases. In some embodiments, operation 320 is performed by the processing device and/or the first generation module 220.

The reference image refers to an image in which an anatomical structure (e.g., an anatomical structure of the heart, the lung, etc.) of the target object is capable of being identified.

In some embodiments, the reference image serves as a generation condition for an image processing model. The generation condition refers to a condition used to guide the image processing model to generate a second image. The plurality of first images may correspond to the same reference image or different reference images, respectively.

In some embodiments, the processing device and/or the first generation module 220 generates the reference image by combining pixel values or voxel values of the first images corresponding to at least two of the plurality of phases.

The combining includes summation, averaging, weighted averaging, or the like. A pixel value of a pixel or a voxel value of a voxel of a first image includes a gray value of the pixel or a voxel of the voxel in the first image.

Taking phase P₁ and phase P₂ as an example, the phase P₁ corresponds to a first image I₁, and the phase P₂ corresponds to a first image I₂. The processing device and/or the first generation module 220 may combine pixel values of pixels at the same position in the first image I₁ and the first image I₂ to determine a pixel value of a pixel at the corresponding position in the reference image. For example, the processing and/or the first generation module 220 may perform summation, averaging, or weighted averaging on a pixel value of a pixel at a first row and a first column in the first image I₁ and a pixel value of a pixel at a first row and a first column in the first image I₂ to determine a pixel value of a pixel at a first row and a first column in the reference image. As another example, the processing device and/or the first generation module 220 may perform summation, averaging, or weighted averaging on a pixel value of a pixel at a first row and a second column in the first image I₁ and a pixel value of a pixel at a first row and a second column in the first image I₂ to determine a pixel value of a pixel at a first row and a second column in the reference image. By analogy, the processing device and/or the first generation module 220 may determine pixel values of all pixels in the reference image, thereby generating the reference image.

In some embodiments, the processing device and/or the first generation module 220 determines at least two k-space datasets by performing a Fourier transform on the first images corresponding to the at least two of the plurality of phases. The processing device and/or the first generation module 220 determines reference k-space data by combining the at least two k-space datasets. The processing device and/or the first generation module 220 generates the reference image by performing an inverse Fourier transform on the reference k-space data.

The k-space dataset refers to a set of k-space data corresponding to a first image. In some embodiments, the processing device and/or the first generation module 220 performs the Fourier transform on the first images corresponding to the at least two phases, respectively, to determine the at least two k-space datasets. A k-space dataset corresponds to a first image.

The reference k-space data refers to k-space data corresponding to the reference image.

In some embodiments, the processing device and/or the first generation module 220 may combine the at least two k-space datasets in various ways to determine the reference k-space data. For example, the processing device and/or the first generation module 220 may combine k-space data at the same position in each k-space dataset to determine k-space data corresponding to the corresponding position in the reference k-space data. The combining includes summation, averaging, weighted averaging, or the like.

Taking phase P₁ and phase P₂ as an example, the phase P₁ corresponds to a first image I₁, and the phase P₂ corresponds to a first image I₂. The processing device and/or the first generation module 220 performs Fourier transform on the first image I₁ and the first image I₂ to determine k-space dataset G₁ and k-space dataset G₂, respectively. The processing device and/or the first generation module 220 combines k-space data at the same position in G₁ and G₂ to determine k-space data at the corresponding position in the reference k-space data. For example, the processing device and/or the first generation module 220 may sum, average, or perform weighted averaging on k-space data at (kx₁, ky₁) in G₁ and k-space data at (kx₁, ky₁) in G₂ to determine k-space data at (kx₁, ky₁) in the reference k-space data, and sum, average, or perform weighted averaging on k-space data at (kx₂, ky₁) in G₁ and k-space data at (kx₂, ky₁) in G₂ to determine k-space data at (kx₂, ky₁) in the reference k-space data, and so on, thereby determining the reference k-space data.

In some embodiments, weights of different first images in the weighted averaging of the pixel or voxel values and/or the k-space data may be preset. For example, the weights may be preset based on experience or automatically preset by a system.

In some embodiments, weights of different first images in the weighted averaging of the pixel or voxel values and/or the k-space data are related to a signal intensity of an original signal (e.g., a magnetic resonance (MR) signal) used to generate the first image. For example, a weight for a first image is negatively correlated with a signal intensity of an original signal used to generate the first image. That is, a greater signal intensity of an original signal used to generate a first image corresponds to a smaller weight of the first image, thereby balancing signal intensities of various phases.

The manner for generating the reference image described above may be understood as the plurality of first images corresponding to the same reference image.

In some embodiments, the processing device and/or the first generation module 220 performs image segmentation on first images corresponding to the at least two of the plurality of phases to determine static regions and dynamic regions in the first images corresponding to the at least two of the plurality of phases.

A static region and a dynamic region are partial regions of a first image. The static region and the dynamic region do not overlap or partially overlap.

The static region refers to a region where a portion of the target object within the region remains stationary throughout the at least two of the plurality of phases. For example, taking the heart as the target object, the static region may be a region corresponding to a non-moving part of the heart (e.g., a fibrous skeleton, epicardial fat, etc.).

The dynamic region refers to a region where a portion of the target object within the region exhibits motion throughout the at least two of the plurality of phases. For example, still taking the heart as the target object, the dynamic region may be a region corresponding to a moving part of the heart (e.g., an atrium, a ventricle, a coronary artery, etc.).

A manner of the image segmentation may be threshold-based segmentation, edge-based segmentation, active contour model-based segmentation, etc., which is not limited herein.

In some embodiments, the processing device and/or the first generation module 220 uses different combination manners for pixels or voxels in the static regions and the dynamic regions of the first images to generate the reference image.

In some embodiments, for the pixels or the voxels in the static regions of the first images corresponding to the at least two of the plurality of phases, a combination manner used by the processing device and/or the first generation module 220 is averaging. For example, the processing device and/or the first generation module 220 averages pixel values of pixels at the same position in the static regions of the first images corresponding to the at least two of the plurality of phases to determine a pixel value of a pixel at the corresponding position in the reference image.

In some embodiments, for the pixels or the voxels in the dynamic regions of the first images corresponding to at least two of the plurality of phases, a combination manner used by the processing device and/or the first generation module 220 is weighted averaging. For example, the processing device and/or the first generation module 220 performs weighted averaging on pixel values of pixels at the same position in the dynamic regions of the first images corresponding to the at least two of the plurality of phases to determine a pixel value of a pixel at the corresponding position in the reference image. Weights corresponding to the pixels in the dynamic regions of different first images are different.

In some embodiments, during the weighted averaging, a weight corresponding to a first image corresponding to a phase temporally closer to a target phase is larger.

The target phase refers to a phase corresponding to a target first image. If a reference image to be generated is used for determining a second image corresponding to a first image among the plurality of first images, the first image is the target first image.

Merely by way of example, taking the at least two phases including phases P₁, P₂, P₃, P₄, P₅, and P₆ as an example, phases P₁, P₂, P₃, P₄, P₅, and P₆ correspond to first images I₁, I₂, I₃, I₄, I₅, and I₆, respectively. Assuming a reference image is to be generated for determining a second image corresponding to the first image I₃, the first image I₃ is the target first image, and the target phase is P₃. The Phase temporally closest to the target phase is P₃, followed by P₂ and P₄, then P₁ and P₅, and finally P₆. Therefore, during the weighted averaging described above for generating the reference image, an order of values of weights corresponding to the six first images is: I₃>I₂=I₄>I₁=I₅>I₆. Understandably, in this case, a specific reference image may be determined for each first image, and the plurality of first images correspond to different reference images.

In some embodiments of the present disclosure, when determining the reference image, information from first images corresponding to a plurality of phases is fused, and differences between dynamic regions and static regions, as well as correlations of information of images corresponding to different phases, are considered. Therefore, multi-phase image information is utilized more intelligently, which can improve subsequent image reconstruction accuracy, particularly for image regions with intense motion or complex structures.

In some embodiments, the processing device and/or the first generation module 220 processes the first images corresponding to the at least two of the plurality of phases using a reference data generation model to generate the reference image corresponding to the target phase. In some embodiments, the processing device and/or the first generation module 220 processes k-space datasets corresponding to the first images corresponding to the at least two of the plurality of phases using the reference data generation model to generate the reference k-space data corresponding to the target phase. The reference image corresponding to the target phase may be generated by performing inverse Fourier transform on the reference k-space data.

The reference data generation model is a machine learning model. For example, the reference data generation model may be a convolutional neural network (CNN) model, a generative adversarial network (GAN) model, etc. An input of the reference data generation model includes the first images corresponding to the at least two of the plurality of phases or k-space datasets corresponding to the first images corresponding to the at least two of the plurality of phases. An output of the reference data generation model includes the reference image corresponding to the target phase or the reference k-space data corresponding to the target phase.

The reference data generation model may be obtained by training an initial machine learning model based on sample data. The sample data includes a plurality of sample first images (the plurality of sample first images correspond to a plurality of sample phases, respectively) or a plurality of k-space datasets corresponding to the plurality of sample first images. The plurality of k-space datasets corresponding to the plurality of sample first images are under-sampled sample k-space datasets. The plurality of sample first images are under-sampled images generated by reconstructing (e.g., via the inverse Fourier transform) the under-sampled sample k-space datasets. A label of the sample data is fully-sampled k-space data corresponding to a sample phase (a sample target phase) among the plurality of sample phases or a fully-sampled image generated by reconstructing (e.g., via the inverse Fourier transform) the fully-sampled k-space data. The under-sampled sample k-space datasets may be selected from under-sampled k-space datasets obtained from historical scanning processes of an imaging device (e.g., the imaging device 110). The under-sampled sample k-space datasets may also be obtained by down-sampling fully-sampled k-space datasets obtained from historical scanning processes of the imaging device.

A process of the training includes: inputting the sample data into the initial machine learning model; determining a value of a loss function based on an output of the initial machine learning model (a reference image or reference k-space data corresponding to the sample target phase) and the label; and iteratively training the initial machine learning model until a preset condition is met (e.g., the value of the loss function is less than a loss threshold, or an iteration count is greater than or equal to a preset count), thereby obtaining a trained reference data generation model. Understandably, in this case, a specific reference image may be generated for each first image, and the plurality of first images correspond to different reference images, respectively.

In some embodiments of the present disclosure, images corresponding to different phases (e.g., first images corresponding to different phases) have different “contribution” for reconstructing an image corresponding to a target phase. By introducing a machine learning model (e.g., the reference data generation model), the model automatically learns importance of images corresponding to different phases, thereby utilizing multi-phase information more intelligently, improving reconstruction accuracy, aligning more easily with a final reconstruction target, and achieving better practical results.

In some embodiments of the present disclosure, a reference image is generated by integrating first images corresponding to at least two of the plurality of phases, and the reference image is used as a generation condition for a subsequent deep learning model based on a conditional diffusion model (the image processing model). This approach yields better denoising effects while enhancing image contrast, allowing a user (e.g., a doctor or a researcher) to observe minute anatomical structures in the image more clearly. The reference image acts as a constraint and guide for an output of the deep learning model based on the conditional diffusion model. By inputting the reference image into the image processing model, the image processing model can synthesize information from different phases to generate a second image with a higher image quality. Compared to using an image corresponding to a single phase as the reference image, multi-phase fusion can reduce noise, enhance contrast, and improve detail display. Therefore, the multi-phase fusion provides clearer and more accurate anatomical structures as a guide for the output of the image processing model, thereby improving denoising effects of the image processing model and an image quality of the output image.

In 330, a plurality of second images are generated by inputting the plurality of first images and the reference image into the image processing model. In some embodiments, operation 330 is performed by the processing device and/or the second generation module 230.

More descriptions regarding the second images may be found in FIG. 1 and related descriptions.

In some embodiments, the image processing model includes a deep learning model based on a conditional diffusion model (CDM).

In some embodiments, any one or a combination of a CNN model, a convolutional recurrent neural network (CRNN) model, a Transformer model, or other custom model structures may be applied in the deep learning model based on the CDM to determine the image processing model.

The CNN model is capable of effectively extracting spatial hierarchical features of an image through convolutional layers, the CNN model has low computational complexity, and the CNN model is capable of being combined with an attention mechanism to enhance image processing capability. The CRNN model is capable of combining the spatial feature extraction capability of the CNN model and the time series processing capability of a recurrent neural network (RNN) model, and the CRNN model is capable of better capturing dependencies among different phases. The Transformers model is capable of utilizing a self-attention mechanism, the Transformer model is good at processing long-range dependencies, and the Transformers model is suitable for processing large datasets and complex models.

In some embodiments, an input of the image processing model includes the plurality of first images and the reference image. In some embodiments, the input of the image processing model includes under-sampled k-space datasets (e.g., raw data) corresponding to the plurality of phases and the reference k-space data. In some embodiments, the input of the image processing model may further include a physiological signal (e.g., a respiratory signal, an electrocardiogram, etc.). When an imaging device performs parallel acquisition, the input of the image processing model may further include a coil sensitivity map. The coil sensitivity map is used to reflect a sensitivity of coils in the imaging device to a received signal or a generated magnetic field at different positions and orientations.

In some embodiments, an output of the image processing model includes the plurality of second images. Each of the plurality of second images corresponds to one of the plurality of first images, and an image quality of the plurality of second image is higher than an image quality of the first image corresponding to the second image. For example, there is a one-to-one correspondence between the plurality of second images and the plurality of first images. In some embodiments, the processing device and/or the second generation module 230 may use a total variation (TV) technique to process the plurality of second images corresponding to the plurality of phases output by the image processing model to ensure smooth transitions among the plurality of second images corresponding to different phases.

In some embodiments, the input and the output of the image processing model may be implemented by a plurality of implementation manners. For example, the plurality of implementation manners include single-channel input/output and multi-channel input/output. For example, taking the single-channel input/output as an example, the image processing model inputs a first image and the reference image corresponding to one phase (or an under-sampled k-space dataset and the reference k-space data corresponding to one phase) at one time, and outputs a second image corresponding to the phase. As another example, taking the multi-channel input/output as an example, the image processing model simultaneously inputs the plurality of first images and the reference image(s) corresponding to the plurality of phases (or the under-sampled k-space datasets and the reference k-space data corresponding to the plurality of phases), each channel of the image processing model processes a first image and the reference image corresponding to one phase (or an under-sampled k-space dataset and the reference k-space data corresponding to one phase), and outputs a second image corresponding to the phase, and the plurality of channels of the image processing model process in parallel.

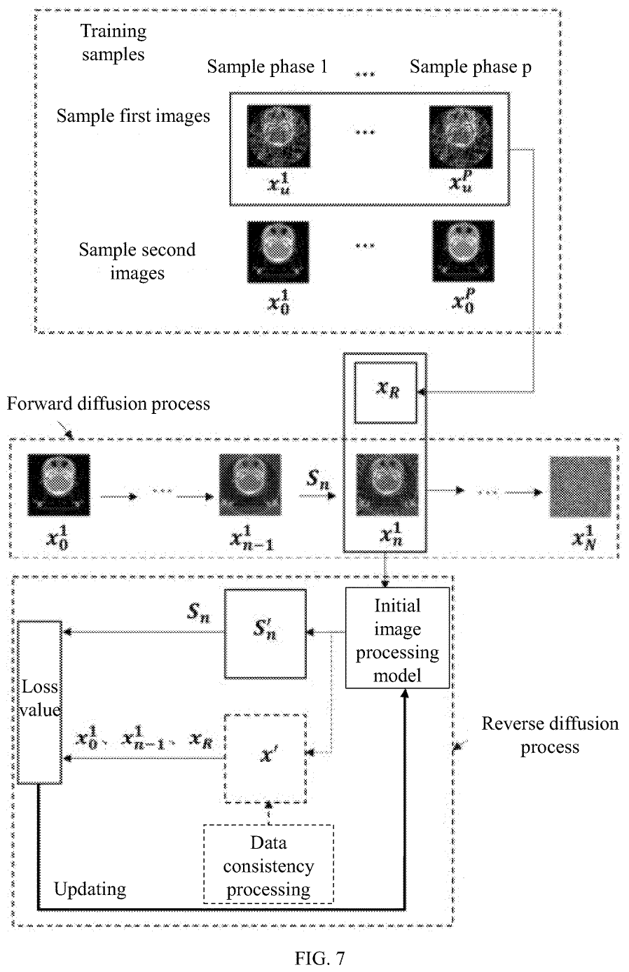

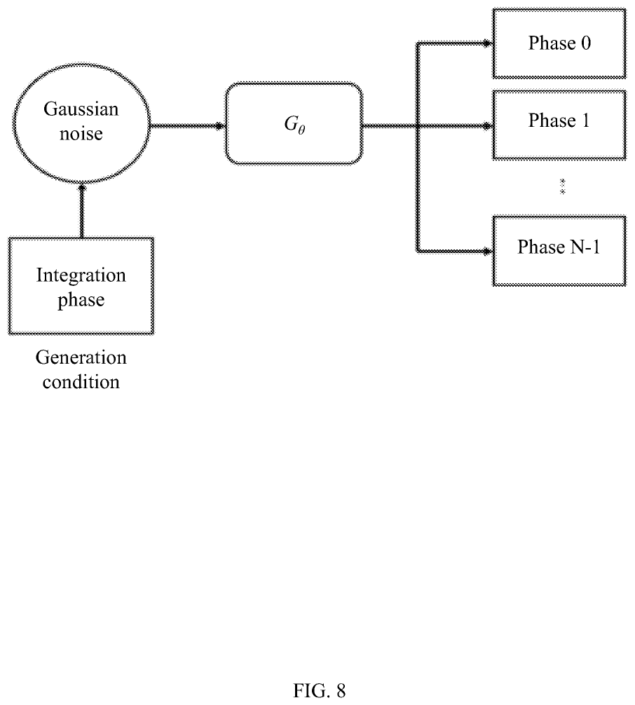

In some embodiments, the processing device and/or the second generation module 230 obtains training samples. The processing device and/or the second generation module 230 determines a sample reference image based on sample first images corresponding to at least two of a plurality of sample phases. The processing device and/or the second generation module 230 obtains the image processing model by training, based on the training samples, an initial image processing model. More descriptions about the above embodiments may be found in FIG. 7 or FIG. 8 and related descriptions. In some embodiments, the training process of the image processing model may be performed by the processing device, or other external devices.

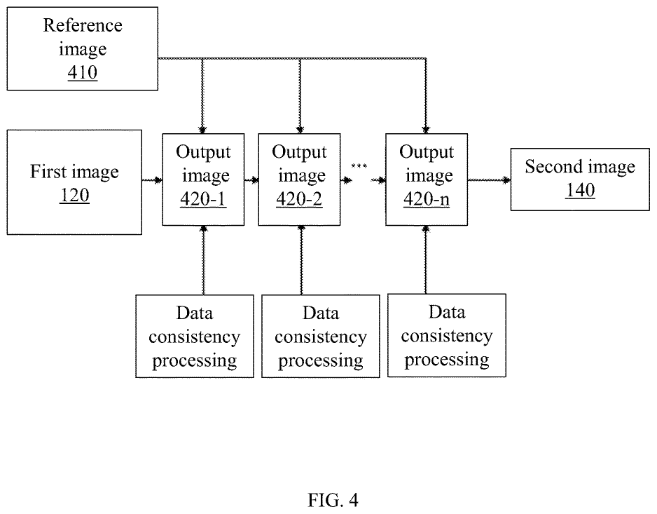

In some embodiments, for each of the plurality of first images, the processing device and/or the second generation module 230 (e.g., the image processing model) performs a plurality of rounds of image processing on the first image based on the reference image, and determines an output image of a last round of image processing as the second image corresponding to the first image. More descriptions about the above embodiments may be found in FIG. 4 to FIG. 6 and related descriptions.

In some embodiments of the present disclosure, the deep learning model based on the CDM is used to process an under-sampled image (e.g., the first image) to generate the second image with a higher quality. The deep learning model based on the CDM accepts an additional generation condition (the reference image) and iteratively removes noise from the under-sampled image, the deep learning model based on the CDM can output the second image that is clearer and richer in detail, the deep learning model based on the CDM has higher denoising efficiency, and the deep learning model based on the CDM has better denoising effect.

It should be noted that the above description of the process 300 is merely for illustration and explanation, and does not limit an applicable scope of the present disclosure. For those skilled in the art, various modifications and changes to the process 300 may be made under the guidance of the present disclosure. However, these modifications and changes are still within the scope of the present disclosure.

FIG. 4 is a schematic diagram illustrating an exemplary process for generating a second image according to some embodiments of the present disclosure.

In some embodiments, as shown in FIG. 4, for each first image 120, the processing device and/or the second generation module 230 uses the image processing model to perform a plurality of rounds of image processing on the first image 120 based on a reference image 410 corresponding to the first image. Each round of image processing includes: generating an output image (e.g., output image 420-1, output image 420-2, . . . , output image 420-n, etc. shown in FIG. 4, wherein n is a count of rounds of the plurality of rounds of image processing) by denoising an input image of the round of image processing based on the reference image 410, wherein the input image is the first image 120 in the first round or an output image of a previous round of image processing in the non-first round. The processing device and/or the second generation module 230 generates the second image 140 corresponding to the first image 120 based on the output image of the last round of image processing (e.g., the output image 420-n).

In some embodiments, as shown in FIG. 4, an input of the first round of image processing is the first image 120, an input of each subsequent round (non-first round) of image processing is the output image of the previous round of image processing (e.g., an input of a second round of image processing is the output image of the first round of image processing, an input of a third round of image processing is the output image of the second round of image processing, etc.), and the output image of the last round of image processing serves as the output of the image processing model, i.e., the second image 140. The image processing of a round includes denoising the input image of the round. Manners of the denoising include mean filtering, bilateral filtering, or any other feasible manner.

In some embodiments, for each round of image processing, the processing device and/or the second generation module 230 generates a denoised image by denoising, based on the reference image, the input image, and generates the output image by performing, based on the first image, data consistency processing on the denoised image. It is to be understood that the processing device and/or the second generation module 230 may generate the second image after performing the data consistency processing on the denoised image generated by the last round of image processing.

The data consistency processing refers to a processing process that constrains consistency among different image data during an image reconstruction process. In some embodiments, the data consistency processing includes using a data expression calculation, adding a constraint condition, or any other feasible manner.

In some embodiments, the processing device and/or the second generation module 230 determines first k-space data by performing a Fourier transform on the first image. The processing device and/or the second generation module 230 determines second k-space data by performing a Fourier transform on the denoised image. The processing device and/or the second generation module 230 determines third k-space data based on the first k-space data and the second k-space data. The processing device and/or the second generation module 230 generates the output image by performing an inverse Fourier transform on the third k-space data.

The first k-space data refers to k-space data determined after performing the Fourier transform on the first image.

The second k-space data refers to k-space data determined after performing the Fourier transform on the denoised image.

The third k-space data refers to k-space data corresponding to the output image.

In some embodiments, the processing device and/or the second generation module 230 combines the first k-space data and the second k-space data to determine the third k-space data. For example, the processing device and/or the second generation module 230 may combine the first k-space data and the second k-space data through a preset formula to determine the third k-space data.

In some embodiments, the preset formula is shown as the following formula (1):

$${K}_{r} = {k}_{{t}^{′}} ( 1 - M ) + {k}_{{i}^{′}} M \qquad ( 1 )$$

In the above formula (1), Kᵣ is the third k-space data, kᵢ is the second k-space data, and kᵢ is the first k-space data. M is a matrix corresponding to kᵢ. Positions of elements in M correspond one-to-one to positions in kᵢ. For a position where data exists in kᵢ (meaning that there is an MR signal filled in the k-space position), a value of an element at a corresponding position in M is set to 1. For a position where data does not exist in kᵢ (meaning that there is no MR signal filled in the k-space position), a value of an element at a corresponding position in M is set to 0. (1−M) is another matrix corresponding to kg. Positions of elements in (1−M) correspond one-to-one to positions in kg. For a position where data exists in kᵢ, a value of an element at a corresponding position in (1−M) is set to 0. For a position where data does not exist in kᵢ, a value of an element at a corresponding position in (1−M) is set to 1. Based on this, kᵢ(1−M) represents retaining data at first positions in kᵢ, wherein the first positions are positions where data does not exist in kᵢ. kᵢM represents retaining data at second positions in kᵢ, wherein the second positions are positions where data exists in kᵢ.

It is to be understood that kᵢ(1−M)+kᵢM may be understood as combining data retained in kᵢ and kᵢ. For a position in the k-space, if data exists at the corresponding position in kᵢ, data at the position is data at the position in kᵢ; if no data exists at the corresponding position in kᵢ, data corresponding to the position is data at the corresponding position in kᵢ.

In some embodiments, the processing device and/or the second generation module 230 may perform the inverse Fourier transform on the third k-space data determined through the above manner to generate the output image.

In some embodiments, each round of processing includes: generating output data by denoising input data of the round of processing based on the reference k-space data, wherein the input data is the k-space data of the first image 120 in the first round or output data of a previous round in the non-first round. The processing device and/or the second generation module 230 generates target k-space data based on the output data of the last round, and generates the second image by performing reconstruction (e.g., inverse Fourier transform) on the target k-space data. This process may be similar to the description in connection with FIG. 4.

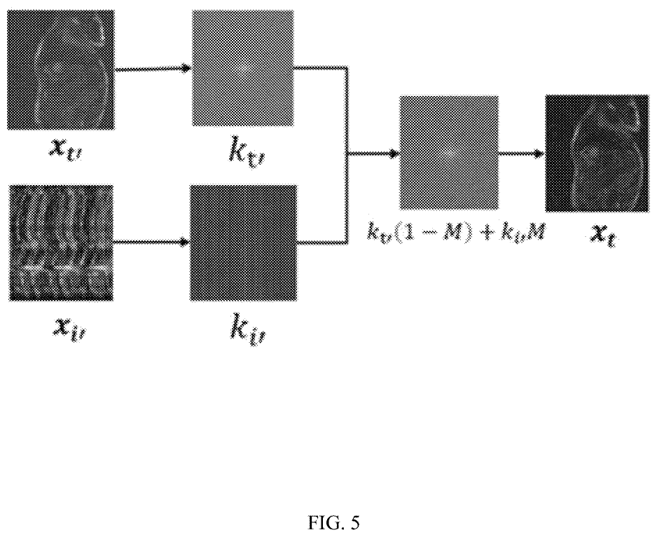

FIG. 5 is a schematic diagram illustrating exemplary data consistency processing according to some embodiments of the present disclosure.

Merely by way of example, as shown in FIG. 5, the processing device and/or the second generation module 230 may perform the data consistency processing through the following process: performing a Fourier transform on a first image xᵢ to determine first k-space data kᵢ; performing a Fourier transform on a denoised image xᵢ to determine second k-space data kᵢ; determining third k-space data kᵢ (1−M)+kᵢM based on the first k-space data kᵢ and the second k-space data kᵢ; and performing an inverse Fourier transform on the third k-space data to generate an output image xᵢ.

In some embodiments, the preset formula is shown as the following formula (2):

$${K}_{r} = {k}_{{t}^{′}} ( 1 - C ) + {k}_{{i}^{′}} C \qquad ( 2 )$$

In the above formula (2), C is a matrix corresponding to kᵢ. Positions of elements in C correspond one-to-one to positions in kᵢ. For a position where data does not exist in kᵢ, a value of an element at the corresponding position in C is set to 0. For a position where data exists in kᵢ, a value of an element at the corresponding position in C is set to c. A value of c is related to a confidence of data at the corresponding position in kᵢ. For example, the value of c is positively correlated with the confidence of the data. (1−C) is another matrix corresponding to kᵢ. Positions of elements in (1−C) correspond one-to-one to positions in kᵢ. For a position where data does not exist in kᵢ, a value of an element at the corresponding position in (1−C) is set to 1. For a position where data exists in kᵢ, a value of an element at the corresponding position in (1−C) is set to 1−c. Meanings of other variables in formula (2) are the same as those in formula (1).

Based on this, kᵢ(1−C)+kᵢC may be understood as follows: for a position in the k-space, if data exists at the position in kᵢ, data at the position in Kᵣ is a weighted sum of data at the corresponding position in kᵢ and data at the corresponding position in kᵢ. A weight of data at the corresponding position in kᵢ is c. A weight of data at the corresponding position in kᵢ is 1−c. If no data exists at the position in kᵢ, data corresponding to the position in Kᵣ is data at the corresponding position in kᵢ.

The confidence reflects a credibility of k-space data at each k-space position. A larger value of a confidence at a k-space position indicates a higher credibility of the k-space data at the k-space position.

In some embodiments, the confidence is determined based on at least one of a signal-to-noise ratio, a data density, and low-frequency information.

The signal-to-noise ratio corresponding to k-space data at a k-space position is determined based on amplitudes of k-space data in a local region (hereinafter referred to as a neighboring region) of the k-space centered on the k-space position. For example, the neighboring region of the k-space position may be a k-space region containing 5×5 k-space positions centered on the k-space position The signal-to-noise ratio corresponding to the k-space data at the k-space position may be a mean or a standard deviation of amplitudes of all k-space data in the neighboring region.

The data density corresponding to k-space data at a k-space position reflects a data density within a neighboring region of the k-space position. The data density is determined based on a count of k-space positions in the neighboring region where data exists and a total count of k-space positions contained in the neighboring region. For example, taking the neighboring region containing 5×5 k-space positions as an example, if there are 10 k-space positions of the 5×5 k-space positions where data exists, the data density is 10/(5×5)=0.4.

The low-frequency information corresponding to k-space data at a k-space position refers to a proportion of low-frequency energy to total energy within a neighboring region of the k-space position. Merely by way of example, the low-frequency information may be determined through the following process (S1 to S4):
In S1, the neighboring region is determined in the k-space. For example, a k-space region containing 5×5 k-space positions centered on the k-space position is determined as the neighboring region of the k-space position.
In S2, a total energy within the neighboring region is determined. The total energy is equal to a sum of squares of the amplitudes of all k-space data within the neighboring region.
In S3, low-pass filtering is performed on all k-space data within the neighboring region.
In S4, a low-frequency energy within the neighboring region is determined. The low-frequency energy is equal to a sum of squares of the amplitudes of all k-space data within the neighboring region after the low-pass filtering.

In some embodiments, the confidence corresponding to k-space data at a k-space position may be a weighted sum of the signal-to-noise ratio, the data density, and the low-frequency information.

In some embodiments, weight values of the signal-to-noise ratio, the data density, and the low-frequency information may be preset. In some embodiments, if a scanning mode of the imaging device is a conventional scan when obtaining the first image, the weight value of the signal-to-noise ratio is equal to the weight value of the data density. In some embodiments, if scanning of the imaging device is performed in a high-noise environment when obtaining the first image, the weight value of the signal-to-noise ratio is greater than the weight values of the data density and the low-frequency information. In some embodiments, if a scanning mode of the imaging device is an ultra-high acceleration scan when obtaining the first image, the weight value of the data density is greater than the weight values of the signal-to-noise ratio and the low-frequency information. In some embodiments, if scanning of the imaging device is a myocardial pathological scan when obtaining the first image, the weight value of the low-frequency information is greater than the weight values of the signal-to-noise ratio and the data density.

In some embodiments, after determining the confidence through the above manner, the processing device and/or the second generation module 230 may further adjust the confidence based on a phase corresponding to the first image. For example, taking the first image being a cardiac image as an example, if the phase corresponding to the first image is at an end-diastolic phase, a confidence in a central region of the k-space is increased. If the phase corresponding to the first image is at an end-systolic phase, a confidence in an edge region (a high-frequency region) of the k-space is increased.

In some embodiments, the data consistency processing may be omitted. The processing device and/or the second generation module 230 may denoise an input image of a current round of image processing based on the reference image to directly generate an output image of the current round of image processing.

In some embodiments of the present disclosure, introducing the data consistency processing during a denoising process ensures consistency between a reconstructed second image and original data (the first image), avoids over-smoothing or distortion, thereby retaining more detail information. The data consistency processing can significantly improve an image quality and provide clearer diagnostic information. The data consistency processing serves as a constraint condition, making a reconstruction process more stable.

In some embodiments of the present disclosure, through the plurality of rounds of image processing, noise and artifacts in an image gradually decrease, and a signal-to-noise ratio, a contrast, and detail display of the image are progressively enhanced. Ultimately, a high-quality second image can be generated. Meanwhile, the plurality of rounds of image processing can gradually optimize the image quality, avoiding over-smoothing or distortion caused by one-time processing. Each round of processing improves upon a previous round, ensuring steady improvement in the image quality.

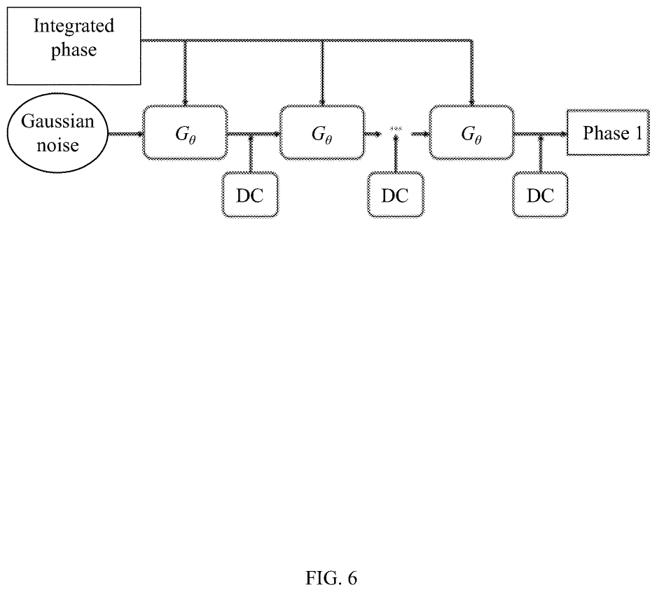

FIG. 6 is a schematic diagram illustrating an exemplary process for generating a second image according to other embodiments of the present disclosure.

In some embodiments, as shown in FIG. 6, taking phase 1 as an example, the processing device and/or the second generation module 230 may use an image processing model to perform a plurality of rounds of image processing based on a first image including noise (e.g., Gaussian noise) and a reference image (an integrated phase). Each round of image processing includes: denoising an input image of the current round of image processing based on the reference image to generate a denoised image Ge; and then performing data consistency processing (i.e., data consistency (DC) shown in FIG. 6) on the denoised image Ge to generate an output image. The input image for the current round of image processing is the first image or an output image from a previous round of image processing. Based on an output image from a final round of image processing, a second image corresponding to a phase corresponding to the first image (e.g., the phase 1) is generated. Descriptions regarding a specific process of FIG. 6 may refer to related descriptions in FIG. 3 to FIG. 5.

FIG. 7 is a schematic diagram illustrating an exemplary training process of an image processing model according to some embodiments of the present disclosure.

In some embodiments, as shown in FIG. 7, a training process of the image processing model includes: obtaining training samples; determining a sample reference image based on sample first images corresponding to at least two of a plurality of sample phases; obtaining the image processing model by training, based on the training samples, an initial image processing model.

In some embodiments, the training samples include at least one set of sample data. Each set of sample data includes a plurality of sample first images and a plurality of sample second images corresponding to a plurality of sample phases of a sample target object. Each of the plurality of sample first images corresponds to one of the plurality of sample phases. Each of the plurality of sample second images corresponds to one of the plurality of sample first images. An image quality of each of the plurality of sample first images is lower than an image quality of the sample second image corresponding to the first sample image. Definitions of the sample target object and the sample phases are similar to definitions of the target object and the phases, respectively, and are not repeated herein.

A sample first image refers to an under-sampled image obtained for the sample target object.

A sample second image refers to a fully-sampled image obtained for the sample target object. The fully-sampled image refers to an image obtained by an imaging device performing a full sampling on a k-space to obtain fully-sampled k-space data during a scanning process for the sample target object, and reconstructing the fully-sampled k-space data. For example, the reconstruction includes an inverse Fourier transform.

In some embodiments, the imaging device (e.g., the imaging device 110) may scan the sample target object within a plurality of sample phases. The processing device and/or the second generation module 230 may use fully-sampled images corresponding to the plurality of sample phases as the sample second images, and use undersampled images corresponding to the plurality of sample phases as the sample first images. Alternatively, the processing device and/or the second generation module 230 may delete partial data from the fully-sampled k-space data corresponding to the plurality of sample second images to obtain under-sampled k-space data corresponding to the plurality of sample phases. The processing device and/or the second generation module 230 may perform an inverse Fourier transform on the under-sampled k-space data corresponding to the plurality of sample phases to generate the plurality of sample first images. Alternatively, the processing device and/or the second generation module 230 may add noise to the plurality of sample second images to generate the plurality of sample first images.

In some embodiments, the processing device and/or the second generation module 230 may perform a normalization process on the sample first images and the sample second images. Merely by way of example, the processing device and/or the second generation module 230 may perform a normalization process on gray values of different images in the training samples to limit the gray values of the images within a certain range, e.g., [0, 1], [0, 255], etc.

The sample reference image refers to an image generated by combining sample first images corresponding to at least two of the plurality of sample phases. The sample reference image and the reference image are substantially similar. A manner for determining the sample reference image based on the sample first images is the same as a manner for determining the reference image based on the first images. A specific implementation of the manner may refer to the manner for determining the reference image based on the first images in operation 320.

In some embodiments, the processing device and/or the second generation module 230 may train the initial image processing model based on the sample reference image and the plurality of sample second images to obtain the image processing model.

In some embodiments, the processing device and/or the second generation module 230 may perform a forward diffusion process on a sample second image. That is, the processing device and/or the second generation module 230 may generate a plurality of noisy images by adding noise to one of the plurality of sample second images multiple times. The processing device and/or the second generation module 230 may select one of the plurality of noisy images as a target noisy image. The processing device and/or the second generation module 230 performs a reverse diffusion process on the target noisy image. That is, the processing device and/or the second generation module 230 determines predicted noise by inputting the target noisy image and the sample reference image into the initial image processing model. The processing device and/or the second generation module 230 determines a loss value of a loss function based on the predicted noise and actual noise corresponding to the target noisy image. The processing device and/or the second generation module 230 obtains the image processing model by updating, based on the loss value, the initial image processing model.

The noisy image refers to an image generated after adding noise to a sample second image.

In some embodiments, the processing device and/or the second generation module 230 adds noise to one of the plurality of sample second images multiple times includes: randomly adding noise to the sample second image to generate a first noisy image; randomly adding noise to the first noisy image to generate a second noisy image, and so on. Repeating the above process to generate the plurality of noisy images, such that the finally generated noisy image approximates a simple distribution. The simple distribution refers to a probability distribution with a simple form and intuitive characteristics. For example, the simple distribution may be a Gaussian distribution, or the like.

The target noisy image refers to a noisy image input into the initial image processing model. In some embodiments, the target noisy image may be selected from the plurality of noisy images by various ways. For example, one noisy image is randomly selected from the plurality of noisy images as the target noisy image.

The predicted noise refers to a noise predicted by the initial image processing model based on the input target noisy image and the sample reference image. The actual noise is a noise actually added to a preceding noisy image of the target noisy image when generating the target noisy image. The preceding noisy image of a noisy image refers to a previous noisy image of the noisy image. Merely by way of example, if the target noisy image is an eighth noisy image among the plurality of noisy images, the actual noise is a noise actually added to a seventh noisy image.

In some embodiments, the processing device and/or the second generation module 230 determines the loss value of the loss function based on the predicted noise and the actually noise corresponding to the target noisy image.

In some embodiments, the loss value is determined based on at least one of a first loss value and a second loss value.

In some embodiments, the processing device and/or the second generation module 230 may determine the first loss value of the loss function in various ways. For example, the processing device and/or the second generation module 230 constructs a first loss function based on the predicted noise and the actual noise corresponding to the target noisy image, and determines a corresponding first loss value. The processing device and/or the second generation module 230 updates the initial image processing model based on the first loss value.

In some embodiments, the processing device and/or the second generation module 230 may further generate a sample denoised image based on the predicted noise and the target noisy image. The processing device and/or the second generation module 230 determines the loss value of the loss function by comparing the sample denoised image with at least one of the preceding noisy image of the target noisy image, the sample reference image, or the one of the plurality of sample second images.

In some embodiments, the processing device and/or the second generation module 230 generates an intermediate image based on the predicted noise and the target noisy image. The processing device and/or the second generation module 230 generates the sample denoised image by performing, based on the preceding noisy image of the target noisy image, data consistency processing on the intermediate image.

A manner for performing the data consistency processing on the intermediate image based on the target noisy image is similar to a manner for performing the data consistency processing on a denoised image based on the first image, which can be found in description in connection with FIG. 4 and FIG. 5.

In some embodiments of the present disclosure, performing the data consistency process on the intermediate image by using the target noisy image not only retains original data in the target noisy image, but also makes the generated sample denoised image closer to a true value. The data consistency processing improves accuracy of the loss value, and further improves fidelity of output data of the image processing model.

The sample denoised image refers to an image generated after performing the data consistency processing on the intermediate image. The intermediate image refers to an image generated after processing the target noisy image. In some embodiments, the processing device and/or the second generation module 230 may remove the predicted noise from the target noisy image to generate the intermediate image.

In some embodiments, the data consistency processing may be omitted. The intermediate image may be directly used as the sample denoised image.

In some embodiments, the processing device and/or the second generation module 230 may construct a second loss function based on the sample denoised image and at least one of a preceding noisy image of the target noisy image, the sample reference image, and the sample second image, and determine a corresponding second loss value. Specifically, the processing device and/or the second generation module 230 may construct the second loss function and determine the corresponding second loss value by comparing the sample denoised image with at least one of a preceding noisy image of the target noisy image, the sample reference image, or the corresponding sample second image.

In some embodiments, the processing device and/or the second generation module 230 may determine a target loss value based on the first loss value and/or the second loss value. The processing device and/or the second generation module 230 may update the initial image processing model based on the target loss value. For example, the processing device and/or the second generation module 230 may perform a weighted average on the first loss value and the second loss value to determine the target loss value.

In some embodiments of the present disclosure, by comparing the sample denoised image with at least one of various images (the preceding noisy image of the target noisy image, the sample reference image, and the sample second image), the determined loss value can be more precise, which is beneficial for subsequent updates of model parameters.

In some embodiments, the loss value further includes a third loss value.

The processing device and/or the second generation module 230 may input sample first images

$${x}_{u}^{1} to {x}_{u}^{p}$$

corresponding to sample phases 1 to P and the sample reference image corresponding to the sample first images

$${x}_{u}^{1} to {x}_{u}^{p}$$

into the initial image processing model, to obtain an output result of the initial image processing model (denoted as R₁ to Rₚ). The processing device and/or the second generation module 230 may determine, based on pixel information (e.g., a grayscale value of a pixel) of pixels at the same position (e.g., the same coordinates) in R₁ to Rₚ, whether a variation of the pixel information conforms to an expected physiological motion pattern (e.g., the change of the pixel information is smooth, or the change of the pixel information is within a preset range). The loss function is constructed based on the variation. For example, the more the variation of the pixel information conforms to the expected physiological motion pattern and/or the smoother the variation is, the smaller the third loss value is; conversely, the less the variation of the pixel information conforms to the expected physiological motion pattern and/or the smaller the degree of smoothness of the variation is, the larger the third loss value is.

In some embodiments of the present disclosure, by utilizing a spatiotemporal smoothness prior of physiological motion, the reconstruction process is further stabilized, artifacts in the second image output by the image processing model can be reduced, and temporal consistency of an entire cine sequence (a plurality of second images) can be improved.

In some embodiments, after completing a current reverse diffusion process, the processing device and/or the second generation module 230 may determine whether a termination condition is satisfied. The termination condition includes convergence of a loss function, a count of executions of the reverse diffusion process reaching a threshold, etc.

In response to a determination that the termination condition is satisfied, an updated model is output as a trained image processing model.

In response to a determination that the termination condition is not satisfied, a next round of reverse diffusion process is continued. Exemplarily, the next round of reverse diffusion process includes: randomly selecting, from the plurality of noisy images, a noisy image different from the target noisy image of a previous round of reverse diffusion process, as a new target noisy image for the next round of reverse diffusion process, and executing the next round of reverse diffusion process. As another example, the reverse diffusion process is executed sequentially according to an order from a finally generated noisy image close to a simple distribution to a first noisy image among the plurality of noisy images. In this case, a preceding noisy image of the target noisy image of the previous round of reverse diffusion process is selected as the target noisy image for the next round of reverse diffusion process, and the next round of reverse diffusion process is executed. In some embodiments, after a forward diffusion process and a reverse diffusion process for one sample second image are completed, the processing device and/or the second generation module 230 may select another sample second image and execute the forward diffusion process and the reverse diffusion process described above.

For example, as shown in FIG. 7, a set of sample data in the training samples includes a plurality of sample first images

$${x}_{u}^{1} ,$$

. . . ,

$${x}_{u}^{P}$$

and a plurality of sample second images

$${x}_{0}^{1} ,$$

. . . ,

$${x}_{0}^{P}$$

corresponding to phases 1 to P of a sample target object. A sample reference image x_{R} is generated by combining sample first images corresponding to at least two sample phases. The processing device and/or the second generation module 230 may execute a forward diffusion process on a sample second image

$${x}_{0}^{1}$$

corresponding to sample phase 1, i.e., add noise to the sample second image

$${x}_{0}^{1}$$

multiple times to generate N noisy images

$${x}_{1}^{1} ,$$

. . . ,

$${x}_{n - 1}^{1} , {x}_{n}^{1} ,$$

. . . , and

$${x}_{N}^{1} .$$

The processing device and/or the second generation module 230 may select a target noisy image

$$( e . g . , {x}_{n}^{1} )$$

from the N noisy images, and execute a reverse diffusion process on the target noisy image

$${x}_{n}^{1} ,$$

i.e., input the target noisy image

$${x}_{n}^{1}$$

and the sample reference image x_{R} into the initial image processing model to determine predicted noise Sₙ′ output by the initial image processing model. The processing device and/or the second generation module 230 may determine a first loss value of a loss function based on the predicted noise Sy′ and actual noise Sy corresponding to the target noisy image, and update the initial image processing model based on the first loss value.

Optionally, the processing device and/or the second generation module 230 may remove the predicted noise Sₙ′ from the target noisy image

$${x}_{n}^{1}$$

to determine an intermediate image, perform data consistency processing on the intermediate image based on the preceding noisy image

$${x}_{n - 1}^{1}$$

of the target noisy image

$${x}_{n}^{1}$$

to generate a sample denoised image x′, compare the sample denoised image x′ with a preceding noisy image

$${x}_{n - 1}^{1} ,$$

the sample reference image x_{R}, and the sample second image

$${x}_{0}^{1} ,$$

respectively, to determine a second loss value, and update the initial image processing model based on the second loss value.

In some embodiments of the present disclosure, by using the noisy image and the sample reference image as inputs, the image processing model can utilize high-quality prior information provided by the sample reference image to better learn how to separate noise from the noisy image, enabling the model to predict noise more accurately and reduce the possibility of misjudgment. By determining the loss value, the image processing model can evaluate the accuracy of the predicted noise and adjust parameters based on the loss value, thereby gradually optimizing performance of the model. By continuously updating parameters of the model, the image processing model can gradually improve its ability to predict noise and ultimately generate a high-quality denoised image.

In some embodiments of the present disclosure, the sample reference image provides high-quality prior information for the image processing model, which can help the model better learn how to recover a high-quality sample second image from a low-quality sample first image. By training the image processing model, image quality can be improved while generalization capability and robustness of the model are enhanced, enabling the model to be widely applied in medical imaging fields such as MRI, CT, PET, etc., significantly improving imaging effects and clinical application value.

FIG. 8 is a schematic diagram illustrating an exemplary training process of an image processing model according to other embodiments of the present disclosure.

In some embodiments, as shown in FIG. 8, a training process of the image processing model includes: collecting a plurality of undersampled images (sample first images) and a plurality of fully sampled images (sample second images) corresponding to N phases (e.g., phase 0, phase 1, . . . , and phase N−1), and performing data normalization processing on the plurality of undersampled images and the plurality of fully sampled images. Noise is gradually added to the fully sampled images to generate a plurality of noisy images Ge, such that the finally generated noisy image includes Gaussian noise. The undersampled images corresponding to the N phases are combined (e.g., summed, averaged) as a generation condition (sample reference image) for a diffusion model. Based on the generation condition, denoising is performed step by step starting from the Gaussian noise, to train an ability of a network to generate fully sampled images corresponding to different phases starting from the generation condition. For a specific process of FIG. 8, reference may be made to the description in FIG. 7.

In some embodiments of the present disclosure, a conditional diffusion model is used in dynamic imaging. Through a forward diffusion process, a plurality of noisy images are generated, making training samples more diverse. By iteratively removing noise from noisy images, the conditional diffusion model can produce clear and detailed results in image reconstruction tasks. By accepting additional conditional information, the conditional diffusion model can generate images that meet specific requirements or features. Compared to some adversarial networks, the training process of the conditional diffusion model is more stable and less susceptible to training instability issues. Meanwhile, the conditional diffusion model can generate reasonable results from a wide range of initial noise levels, and is less likely to experience significant degradation in generation quality due to fluctuations in input noise levels. The conditional diffusion model loses information during the forward diffusion process and then recovers the information during the reverse diffusion process, and does not directly rely on specific features of original training samples, thus possessing strong anti-overfitting capability.

The method for dynamic medical imaging can be applied to cardiac MRI dynamic reconstruction. Therefore, the present disclosure provides a cardiac MRI cine reconstruction method based on a conditional diffusion generation network, aiming to recover high-quality cardiac cine from highly undersampled k-space data. Cardiac MRI cine imaging provides comprehensive information about the heart and plays a key role in cardiac diagnosis and management. However, to capture fast real-time dynamic information, each phase of the MRI cine cannot fully acquire signals required for image reconstruction. Existing technologies have shortcomings in reconstruction speed and accuracy, which may lead to degradation of cine quality and loss of information. The present disclosure proposes using a deep learning network based on a conditional diffusion model, which can fully utilize information from different phases and introduce data consistency processing to ensure authenticity of generated images, thereby quickly recovering high-quality cardiac MRI cine from highly undersampled images, and enabling fast and high-precision reconstruction of cardiac cine for newly scanned patients. This manner can significantly improve clinical utility and accuracy of the cardiac MRI cine, help doctors better observe and diagnose, and contribute to better assessment of cardiac function and health status.

For convenience of description, the present disclosure uses magnetic resonance dynamic imaging as an example for description. It is to be understood that the method for dynamic medical imaging described in the present disclosure may also be applied to dynamic imaging of other modalities. For example, the method for dynamic medical imaging may be applied to computed tomography (CT) dynamic imaging, or the like. The method for dynamic medical imaging is substantially similar when applied to the CT dynamic imaging and when applied to the magnetic resonance dynamic imaging.

In the CT dynamic imaging, a first image refers to a sparsely sampled image obtained by an imaging device. During a scanning process for a target object, the imaging device performs sparse sampling to obtain sparsely sampled projection data. The imaging device reconstructs the sparsely sampled projection data (e.g., via filtered back projection) to obtain the first image. In the sparse sampling, a count of projection angles acquired during scanning is less than a count of projection angles in full sampling. For example, in the full sampling, the projection data is obtained once per 1° or 0.5° within a range of 360° or 180°+θ (a fan angle of an X-ray beam). In the sparse sampling, the projection data is obtained only at a portion of projection angles corresponding to projection angles of the full sampling.

In the CT dynamic imaging, a sample first image refers to a sparsely sampled image obtained for a sample target object. A sample second image refers to a fully sampled image obtained for the sample target object. The fully sampled image refers to an image obtained by performing full sampling on the sample target object during a scanning process by the imaging device to obtain fully sampled projection data, and reconstructing the fully sampled projection data (e.g., via filtered back projection or iterative reconstruction, or the like). For example, the projection data is obtained once per 1° or 0.5° within a range of 360° or 180°+θ (the fan angle of the X-ray beam) to obtain the fully sampled projection data. The system for dynamic medical imaging may scan the sample target object in a plurality of sample phases. The system for dynamic medical imaging uses fully sampled images corresponding to the plurality of sample phases as sample second images, and uses sparsely sampled images corresponding to the plurality of sample phases as the sample first images. Alternatively, the system for dynamic medical imaging deletes projection data corresponding to a portion of projection angles from fully sampled projection data corresponding to the plurality of sample second images to obtain sparse projection data corresponding to the plurality of sample phases. The system for dynamic medical imaging performs filtered back projection on the sparse projection data corresponding to the plurality of sample phases to obtain a plurality of sample first images. Alternatively, noise may be added to the plurality of sample second images to generate the plurality of sample first images.

From the above description, the input and the output of the image processing model in an image form (e.g., MRI images, or CT images) are taken as an example to illustrate the dynamic medical imaging. It should be noted that the input and the output of the image processing model also can be in a form of raw data (e.g., k-space data in MRI, or projection data in CT). For example, the input of the image processing model includes a plurality of undersampled k-space datasets corresponding to a plurality of phases and reference k-space data. The output of the image processing model includes a plurality of target k-space datasets corresponding to the plurality of undersampled k-space datasets. A plurality of second images may be generated by reconstructing the plurality of target k-space datasets. The principle of dynamic medical imaging in which the input and the output of the image processing model are in a form of raw data is similar to that of dynamic medical imaging in which the input and the output of the image processing model are in an image form, which will not be repeated here. The principle of model training in which the input and the output of the image processing model are in a form of raw data is similar to that of model training in which the input and the output of the image processing model are in an image form, which will not be repeated here. The determination of the reference k-space data can be found in descriptions in connection with operation 320 of the process 300 in FIG. 3.

The basic concepts have been described above. Obviously, to a person skilled in the art, the detailed disclosure above is merely an example and does not constitute a limitation on the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. Terms such as “one embodiment,” “an embodiment,” and/or “some embodiments” mean a certain feature, structure, or characteristic related to at least one embodiment of the present disclosure. Therefore, it is emphasized and noted that “an embodiment” or “one embodiment” or “an alternative embodiment” mentioned two or more times in different places in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure are not used to limit the order of processes and methods of the present disclosure. Although the foregoing disclosure discusses some embodiments of the invention currently considered useful through various examples, it is to be understood that such details are for illustrative purposes only. The appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it is to be noted that, in order to simplify the expression disclosed in the present disclosure and thereby help understand one or more embodiments of the invention, multiple features are sometimes grouped into one embodiment, drawing, or description thereof in the foregoing description of the embodiments of the present disclosure. However, this disclosure method does not mean that the object of the present disclosure requires more features than the features mentioned in the claims. Rather, claimed subject matter may lie in less than all features of a single foregoing disclosed embodiment.

In some embodiments, numbers describing quantities of ingredients and properties are used. It is to be understood that such numbers used in the description of the embodiments are modified by terms such as “about,” “approximately,” or “substantially” in some examples. Unless otherwise stated, “about,” “approximately,” or “substantially” indicates that the stated number allows a variation of ±20%. Accordingly, in some embodiments, numerical parameters used in the specification and claims are approximate values. The approximate values may vary according to the characteristics required by individual embodiments. In some embodiments, numerical parameters should consider the prescribed number of significant digits and adopt the method of general digit retention. Although numerical ranges and parameters used to confirm the breadth of the scope in some embodiments of the present disclosure are approximate values, such numerical values are set as precisely as possible within a feasible range in specific embodiments.

For each patent, patent application, patent application publication, and other material, such as articles, books, specifications, publications, documents, etc., cited in the present disclosure, the entire content thereof is hereby incorporated into the present disclosure by reference. Application history documents that are inconsistent with or conflict with the content of the present disclosure are excluded. Documents (currently or later attached to the present disclosure) that limit the broadest scope of the claims of the present disclosure are also excluded. It is to be noted that, if the description, definition, and/or use of terms in the attached materials of the present disclosure are inconsistent with or conflict with the content described in the present disclosure, the description, definition, and/or use of terms in the present disclosure prevail.

Finally, it is to be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A method for dynamic medical imaging, comprising:
obtaining a plurality of first images of a target object corresponding to a plurality of phases, each of the plurality of first images corresponding to one of the plurality of phases;
generating a reference image based on first images corresponding to at least two of the plurality of phases; and
generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image.

2. The method of claim 1, wherein the generating a reference image based on the first images corresponding to at least two of the plurality of phases includes:
determining at least two k-space datasets by performing a Fourier transform on the first images corresponding to the at least two of the plurality of phases;
determining reference k-space data by combining the at least two k-space datasets; and
generating the reference image by performing an inverse Fourier transform on the reference k-space data.

3. The method of claim 1, wherein the generating a reference image based on the first images corresponding to at least two of the plurality of phases includes:
generating the reference image by combining pixel values or voxel values of the first images corresponding to the at least two of the plurality of phases.

4. The method of claim 1, wherein the generating a plurality of second images by inputting the plurality of first images and the reference image into an image processing model includes:
for each of the plurality of first images,
performing a plurality of rounds of image processing on the first image based on the reference image, each of the plurality of rounds of image processing including:
generating an output image by denoising, based on the reference image, an input image, the input image being the first image or an output image of a previous round of image processing; and
determining the output image of a last round of image processing as the second image corresponding to the first image.

5. The method of claim 4, wherein the generating an output image by denoising, based on the reference image, an input image includes:
generating a denoised image by denoising, based on the reference image, the input image; and
generating the output image by performing, based on the first image, data consistency processing on the denoised image.

6. The method of claim 5, wherein the generating the output image by performing, based on the first image, data consistency processing on the denoised image includes:
determining first k-space data by performing a Fourier transform on the first image;
determining second k-space data by performing a Fourier transform on the denoised image;
determining third k-space data based on the first k-space data and the second k-space data; and
generating the output image by performing an inverse Fourier transform on the third k-space data.

7. The method of claim 1, wherein the image processing model is a deep learning model based on a conditional diffusion model.

8. The method of claim 7, wherein the image processing model is provided by:
obtaining training samples, the training samples including a plurality of sample first images and a plurality of sample second images corresponding to a plurality of sample phases of a sample object, each of the plurality of sample first images corresponding to one of the plurality of sample phases, each of the plurality of sample second images corresponding to one of the plurality of sample first images, and an image quality of each of the plurality of sample first images being lower than an image quality of the sample second image corresponding to the sample first image;
determining a sample reference image based on sample first images corresponding to at least two of the plurality of sample phases; and
obtaining the image processing model by training, based on the training samples, an initial image processing model.

9. The method of claim 8, wherein the obtaining the image processing model by training, based on the training samples, an initial image processing model includes:
generating a plurality of noisy images by adding noise to one of the plurality of sample second images multiple times;
selecting one of the plurality of noisy images as a target noisy image;
determining predicted noise by inputting the target noisy image and the sample reference image into the initial image processing model;
determining a loss value of a loss function based on the predicted noise and the noise corresponding to the target noisy image; and
obtaining the image processing model by updating, based on the loss value, the initial image processing model.

10. The method of claim 9, wherein the obtaining the image processing model by training, based on the training samples, an initial image processing model further includes:
generating a sample denoised image based on the target noisy image and the sample reference image; and
determining the loss value of the loss function by comparing the sample denoised image with at least one of a preceding noisy image of the target noisy image, the sample reference image, or the one of the plurality of sample second images.

11. The method of claim 10, wherein the generating a sample denoised image based on the target noisy image and the sample reference image includes:
generating an intermediate image based on the target noisy image and the sample reference image; and
generating the sample denoised image by performing, based on the preceding noisy image of the target noisy image, data consistency processing on the intermediate image.

12. A system for dynamic medical imaging, comprising:
at least one storage medium including a set of instructions; and
at least one processor in communication with the at least one storage medium, wherein when executing the set of instructions, the at least one processor is directed to cause the system to perform operations including:
obtaining a plurality of first images of a target object corresponding to a plurality of phases, each of the plurality of first images corresponding to one of the plurality of phases;
generating a reference image based on first images corresponding to at least two of the plurality of phases; and
generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image.

13. The system of claim 12, wherein the generating a plurality of second images by inputting the plurality of first images and the reference image into an image processing model includes:
for each of the plurality of first images,
performing a plurality of rounds of image processing on the first image based on the reference image, each of the plurality of rounds of image processing including:
generating an output image by denoising, based on the reference image, an input image, the input image being the first image or an output image of a previous round of image processing; and
determining the output image of a last round of image processing as the second image corresponding to the first image.

14. The system of claim 13, wherein the generating an output image by denoising, based on the reference image, an input image includes:
generating a denoised image by denoising, based on the reference image, the input image; and
generating the output image by performing, based on the first image, data consistency processing on the denoised image.

15. The system of claim 14, wherein the generating the output image by performing, based on the first image, data consistency processing on the denoised image includes:
determining first k-space data by performing a Fourier transform on the first image;
determining second k-space data by performing a Fourier transform on the denoised image;
determining third k-space data based on the first k-space data and the second k-space data; and
generating the output image by performing an inverse Fourier transform on the third k-space data.

16. The system of claim 12, wherein the image processing model is provided by:
obtaining training samples, the training samples including a plurality of sample first images and a plurality of sample second images corresponding to a plurality of sample phases of a sample object, each of the plurality of sample first images corresponding to one of the plurality of sample phases, each of the plurality of sample second images corresponding to one of the plurality of sample first images, and an image quality of each of the plurality of sample first images being lower than an image quality of the sample second image corresponding to the sample first image;
determining a sample reference image based on sample first images corresponding to at least two of the plurality of sample phases; and
obtaining the image processing model by training, based on the training samples, an initial image processing model.

17. The system of claim 16, wherein the obtaining the image processing model by training, based on the training samples, an initial image processing model includes:
generating a plurality of noisy images by adding noise to one of the plurality of sample second images multiple times;
selecting one of the plurality of noisy images as a target noisy image;
determining predicted noise by inputting the target noisy image and the sample reference image into the initial image processing model;
determining a loss value of a loss function based on the predicted noise and the noise corresponding to the target noisy image; and
obtaining the image processing model by updating, based on the loss value, the initial image processing model.

18. The system of claim 17, wherein the obtaining the image processing model by training, based on the training samples, an initial image processing model further includes:
generating a sample denoised image based on the target noisy image and the sample reference image; and
determining the loss value of the loss function by comparing the sample denoised image with at least one of a preceding noisy image of the target noisy image, the sample reference image, or the one of the plurality of sample second images.

19. The system of claim 18, wherein the generating a sample denoised image based on the target noisy image and the sample reference image includes:
generating an intermediate image based on the target noisy image and the sample reference image; and
generating the sample denoised image by performing, based on the preceding noisy image of the target noisy image, data consistency processing on the intermediate image.

20. A computer-readable storage medium storing computer instructions, wherein when a computer reads the computer instructions in the storage medium, the computer implements:
obtaining a plurality of first images of a target object corresponding to a plurality of phases, each of the plurality of first images corresponding to one of the plurality of phases;
generating a reference image based on first images corresponding to at least two of the plurality of phases; and
generating a plurality of second images by inputting the plurality of first images and the reference image into an image processing model, each of the plurality of second images corresponding to one of the plurality of first images, and an image quality of each of the plurality of second images being higher than an image quality of the first image corresponding to the second image.
